(19) United States
(12) Patent Application Publication
(10) Pub. No.: US 2016/0011294 A1
(43) Pub. Date: Jan. 14, 2016

(54) APPARATUS AND METHOD FOR ESTIMATING LOCATION, ELECTRONIC APPARATUS COMPRISING THE APPARATUS

(71) Applicant: ELECTRONICS AND TELECOMMUNICATIONS RESEARCH INSTITUTE, Daejeon (KR)

(72) Inventors: Jae Hyun KIM, Daejeon (KR); Jae Hoon KIM, Daejeon (KR); Cheon Sig SIN, Daejeon (KR); Sang Uk LEE, Daejeon (KR)

(21) Appl. No.: 14/748,519

(22) Filed: Jun. 24, 2015

(30) Foreign Application Priority Data
Jul. 11, 2014 (KR) 10-2014-0087436

(51) Int. Cl. G01S 5/00; G01S 5/02

(52) U.S. Cl. CPC G01S 5/0063; G01S 5/0284

(57) ABSTRACT

A location estimating apparatus according to an exemplary embodiment of the present invention is a location estimating apparatus which estimates a position of an electronic apparatus, including a distance calculating unit which calculates a distance from an AP using a strength (RSSI) of an AP signal which is received from the AP; an azimuth calculating unit which calculates an azimuth of the AP with respect to a reference direction using an entrance angle of the AP signal; a position information acquiring unit which acquires position information of the AP from the AP signal; a correction information generating unit which generates correction information based on detection information for movement of the electronic apparatus; and a position information generating unit which generates position information of the electronic apparatus using the distance from the AP and the azimuth based on the position information of the AP and corrects the position information of the electronic apparatus using the correction information.

### CROSS-REFERENCE TO RELATED APPLICATIONS

This application claims priority to and the benefit of Korean Patent Application No. 10-2014-0087436 filed in the Korean Intellectual Property Office on Jul. 11, 2014, the entire contents of which are incorporated herein by reference.

### TECHNICAL FIELD

The present invention relates to an apparatus and a method for estimating a location and an electronic apparatus including the apparatus.

### BACKGROUND ART

As demands on a smart phone and a location based service using the smart phone are increased, demands on an indoor positioning technique which may precisely recognize a position of a terminal inside to reduce necessary expenses are increased. A general indoor positioning system is divided into a wireless AP method which provides a dedicated wireless access point (AP) such as WiFi, UWB, ZigBee, or pseudolite to use information from the AP, a method of using a mobile communication base station signal, and a method which uses a sensor installed in the terminal.

In the case of the wireless AP method, it is expensive to provide APs and an electric wave map needs to be built according to various indoor electric wave environments while an installation location of the AP needs to be adjusted. Specifically, the wireless AP method has a problem in that at least four APs are required to perform indoor positioning. In the case of the base station method, an intensity of a reception signal at each base station for a transmission signal of a terminal is measured to find a location through the electric wave map, resulting in a large positional error (200 to 300 m) and in many cases, it is difficult to receive signals from a plurality of base stations inside. The method which uses a sensor is used to connect with a GPS navigation system. According to the method which uses a sensor, precision of provided position information is accurate outside but a GPS signal cannot be received inside so that an error is increased in accordance with the divergence of the sensor and a reference point inside needs to be noticed.

### SUMMARY OF THE INVENTION

The present invention has been made in an effort to provide an apparatus and a method for estimating a location and an electronic apparatus including the apparatus which may precisely estimate a location of an electronic apparatus inside without additionally providing additional equipment.

Technical objects of the present invention are not limited to the aforementioned technical objects and other technical objects which are not mentioned will be apparently appreciated by those skilled in the art from the following description.

An exemplary embodiment of the present invention provides a location estimating apparatus which estimates a position of an electronic apparatus, including a distance calculating unit which calculates a distance from an AP using a strength (RSSI) of an AP signal which is received from the AP; an azimuth calculating unit which calculates an azimuth of the AP with respect to a reference direction using an entrance angle of the AP signal; a position information acquiring unit which acquires position information of the AP from the AP signal; a correction information generating unit which generates correction information based on detection information for movement of the electronic apparatus; and a position information generating unit which generates position information of the electronic apparatus using the distance from the AP and the azimuth based on the position information of the AP and corrects the position information of the electronic apparatus using the correction information.

The location estimating apparatus may be disposed in the electronic apparatus to receive the AP signal from the AP.

When the electronic apparatus is disposed inside, the reference direction may be defined as a direction which is perpendicular to the ground.

The correction information may include acceleration information and direction information with respect to the movement of the electronic apparatus.

When the distance from the AP is larger than a reference value, the position information generating unit may correct the position information of the electronic apparatus using the correction information.

The AP signal may include a message including position information of the AP.

When the electronic apparatus is disposed inside, the electronic apparatus may receive the AP signal from the AP.

Another exemplary embodiment of the present invention provides a location estimating method which estimates a position of an electronic apparatus, including calculating a distance from an AP using a strength (RSSI) of an AP signal which is received from the AP; calculating an azimuth of the AP with respect to a reference direction using an entrance angle of the AP signal; acquiring position information of the AP from the AP signal; generating correction information based on detection information for movement of the electronic apparatus; generating position information of the electronic apparatus using the distance from the AP and the azimuth based on the position information of the AP; and correcting the position information of the electronic apparatus using the correction information.

Yet another exemplary embodiment of the present invention provides an electronic apparatus, including: a receiving unit which receives an AP signal from an AP; an INS sensor which detects movement of the electronic apparatus to generate detection information; and a location estimating unit which calculates a distance between the electronic apparatus and the AP using a strength (RSSI) of the AP signal, calculates an azimuth of the AP with respect to a reference direction using an entrance angle of the AP signal, generates the position information of the electronic apparatus using the distance and the azimuth based on the position information of the AP which is acquired from the AP signal, and corrects the estimated position information of the electronic apparatus using the correction information which is generated based on the detection information.

The location estimating unit may include: a distance calculating unit which calculates a distance from the AP; an azimuth calculating unit which calculates an azimuth of the AP; a position information acquiring unit which acquires position information of the AP from the AP signal; a correction information generating unit which generates the correction information based on the detection information; and a position information generating unit which generates position information of the electronic apparatus using the distance from the AP and the azimuth based on the position information of the AP and corrects the position information of the electronic apparatus using the correction information.

When the distance from the AP is larger than a reference value, the position information generating unit may correct the position information of the electronic apparatus using the correction information.

The correction information may include acceleration information and direction information with respect to the movement of the electronic apparatus.

When the electronic apparatus is disposed inside, the reference direction may be defined as a direction which is perpendicular to the ground.

Still another exemplary embodiment of the present invention provides a location estimating apparatus which estimates a position of an electronic apparatus, including a distance calculating unit which calculates a distance from an AP using a strength (RSSI) of an AP signal which is received from the AP; an azimuth calculating unit which calculates an azimuth of the AP with respect to a reference direction using an entrance angle of the AP signal; a position information acquiring unit which acquires position information of the AP from the AP signal; a position information generating unit which generates position information of the electronic apparatus using the distance from the AP and the azimuth based on the position information of the AP.

According to an apparatus and a method for estimating a location and an electronic apparatus including the apparatus according to an exemplary embodiment of the present invention, it is possible to precisely estimate a location of an electronic apparatus inside without additionally providing additional equipment.

An apparatus and a method of estimating a location and an electronic apparatus including the apparatus according to an exemplary embodiment of the present invention may correct the estimated position information using information of a speed and a direction of the electronic apparatus, thereby generating more precise position information.

### BRIEF DESCRIPTION OF THE DRAWINGS

FIG. 1 illustrates communication between an electronic apparatus according to an exemplary embodiment of the present invention and an AP.

FIG. 2 is a block diagram specifically illustrating an electronic apparatus according to an exemplary embodiment of the present invention.

FIG. 3 is a block diagram illustrating a location estimating apparatus according to an exemplary embodiment of the present invention.

FIG. 4 is a flowchart illustrating a location estimating method according to an exemplary embodiment of the present invention.

FIG. 5 is a block diagram illustrating a computing system which executes a location estimating method according to an exemplary embodiment of the present invention.

It should be understood that the appended drawings are not necessarily to scale, presenting a somewhat simplified representation of various features illustrative of the basic principles of the invention. The specific design features of the present invention as disclosed herein, including, for example, specific dimensions, orientations, locations, and shapes will be determined in part by the particular intended application and use environment.

In the figures, reference numbers refer to the same or equivalent parts of the present invention throughout the several figures of the drawing.

### DETAILED DESCRIPTION OF THE INVENTION

Hereinafter, some embodiments of the present invention will be described in detail with reference to the accompanying drawings. In the figures, even though the parts are illustrated in different drawings, it should be understood that like reference numbers refer to the same or equivalent parts. In describing the embodiments of the present invention, when it is determined that the detailed description of the known art related to the present invention may obscure the gist of the present invention, the detailed description thereof will be omitted.

In describing components of the exemplary embodiment of the present invention, terminologies such as first, second, A, B, (a), (b), and the like may be used. However, such terminologies are used only to distinguish a component from another component but a nature or an order of the component is not limited by the terminologies. If they are not contrarily defined, all terms used herein including technological or scientific terms have the same meaning as those generally understood by a person with ordinary skill in the art. Terms which are defined in a generally used dictionary should be interpreted to have the same meaning as the meaning in the context of the related art but are not interpreted as an ideally or excessively formal meaning if they are not clearly defined in the present application.

The present invention relates to a location estimating apparatus, an estimating method, and an electronic apparatus including a location estimating apparatus and more particularly, to a location estimating apparatus, an estimating method, and an electronic apparatus including a location estimating apparatus which perform indoor positioning using one access point (AP). Hereinafter, a location estimating apparatus, an estimating method, and an electronic apparatus including a location estimating apparatus according to an exemplary embodiment of the present invention will be described in detail with reference to the drawings.

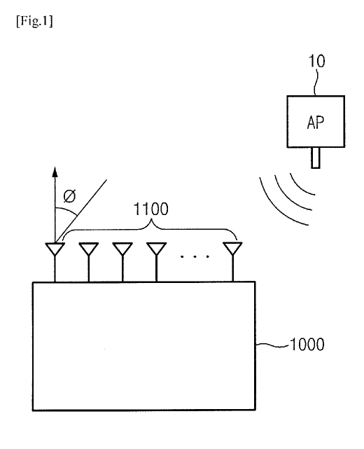

FIG. 1 illustrates communication between an electronic apparatus according to an exemplary embodiment of the present invention and an AP.

Referring to FIG. 1, an electronic apparatus 1000 according to an exemplary embodiment of the present invention may communicate with an AP 10 using an array antenna 1100. In FIG. 1, it is assumed that the electronic apparatus 1000 and the AP 10 are disposed inside to communicate with each other. The AP 10 may be provided on a ceiling or a wall inside a building.

The electronic apparatus 1000 may include a tablet personal computer (PC), a smart phone, a digital camera, a portable multimedia player (PMP), a media player, a portable game machine, a personal digital assistant (PDA), in addition to a mobile communication terminal which operates based on various communication protocols corresponding to various communication systems. Hereinafter, the electronic apparatus 1000 is assumed to be a smart phone, but the electronic apparatus 1000 is not limited thereto.

The electronic apparatus 1000 may receive an AP signal from the AP 10 through the array antenna 1100. For example, the AP signal may have a message format for indoor positioning of the electronic apparatus 100. The AP signal may include the AP message including position information of the AP 10. For example, the position information of the AP 10 may be defined by a three-dimensional coordinate (x, y, z).

The electronic apparatus 1000 communicates with the AP 10 to measure a direction in which the AP 10 is located and a distance from the AP 10. The electronic device 1000 may measure a direction in which the AP 10 is located based on an AP signal received from the AP 10. For example, the electronic apparatus 1000 may generate direction information of the AP 10 which is defined as an azimuth Φ. The electronic apparatus 1000 may measure a distance from the AP 10 using a strength (RSSI: received signal strength indicator) of the AP signal which is received from the AP 10. The electronic apparatus 1000 may estimate the position information of the electronic apparatus 1000 using the direction of the AP 10 and the distance from the AP 10 based on the position information of the AP 10 which is included in the AP signal.

The electronic apparatus 1000 may correct the estimated position information based on detection information which is detected from an INS (internal navigation system) sensor (not illustrated) disposed inside. For example, when the electronic apparatus 1000 is moved by a user, the electronic apparatus 1000 may correct the position information based on the detection information to generate more precise position information.

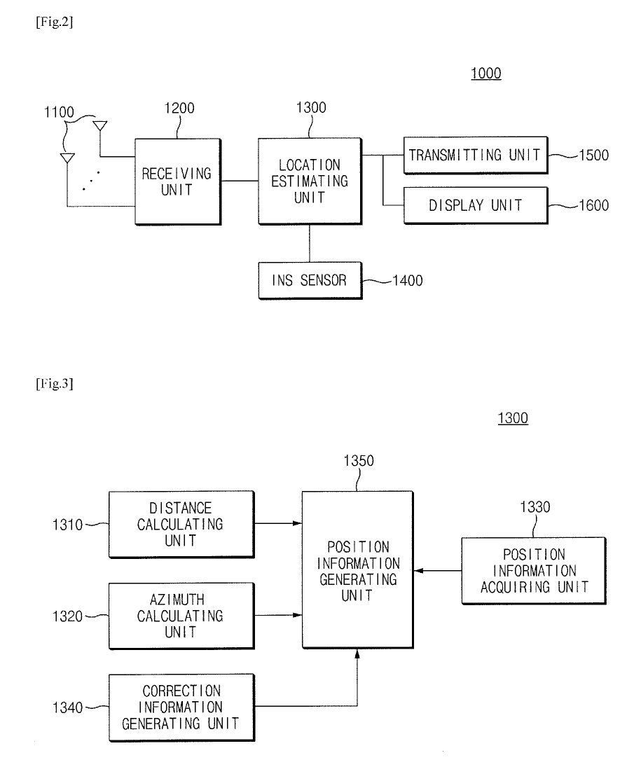

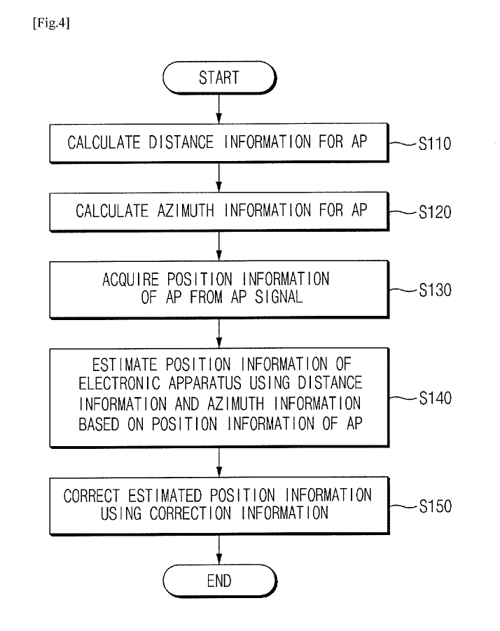

The electronic apparatus 100 described above will be described in more detail with reference to FIGS. 2 and 3.

FIG. 2 is a block diagram specifically illustrating an electronic apparatus according to an exemplary embodiment of the present invention. FIG. 3 is a block diagram illustrating a location estimating apparatus according to an exemplary embodiment of the present invention.

First, referring to FIG. 2, the electronic apparatus 1000 according to an exemplary embodiment of the present invention may include an array antenna 1100, a receiving unit 1200, a location estimating unit 1300, an INS sensor 1400, a transmitting unit 1500, and a display unit 1600.

The receiving unit 1200 may receive an AP signal from the AP 10 (see FIG. 1) through the array antenna 1100. The receiving unit 1200 transmits the received AP signal to the location estimating unit 1300. The AP signal may include an AP message including position information of the AP 10. For example, the position information of the AP 10 may be defined by a three-dimensional coordinate (x, y, z).

The location estimating unit 1300 may measure the direction of the AP 10 and the distance from the AP 10 using the AP signal which is transmitted from the receiving unit 1200. For example, the direction of the AP 10 may indicate a direction in which the AP 10 is located with respect to the electronic apparatus 1000. The distance from the AP 10 may indicate a straight-line distance between the electronic apparatus 1000 and the AP 10. That is, since the AP signal includes the position information of the AP 10, the location estimating unit 1300 may measure the direction of the AP 10 and the distance from the AP 10 to estimate the location of the electronic apparatus 1000. A specific configuration and operation of the location estimating unit 1300 will be described with reference to FIG. 3.

Referring to FIG. 3, the location estimating unit 1300 may include a distance calculating unit 1310, an azimuth calculating unit 1320, a position information acquiring unit 1330, a correction information generating unit 1340, and a position information generating unit 1350.

The distance calculating unit 1310 may calculate the distance from the AP 10 using the strength RSSI of the AP signal.

The azimuth calculating unit 1320 may calculate an azimuth Φ (see FIG. 1) with respect to the position of the AP 10 using an entrance angle of the AP signal which is input to the array antenna 1100. For example, the azimuth may indicate a direction of the AP 10 with respect to the electronic apparatus 1000. The azimuth may be calculated based on a reference direction and the reference direction (for example, a direction perpendicular to the ground inside) may be set in advance.

The position information acquiring unit 1330 may acquire position information of the AP 10 from the received AP signal.

The correction information generating unit 1340 may generate correction information based on detection information which is transmitted from the INS sensor 1400 (see FIG. 2). The detection information may include information on movement, acceleration, a direction, and a gradient of the electronic apparatus 1000 and for example, may include acceleration information and direction information. Specifically, the correction information generating unit 1340 may calculate a speed and a movement distance in accordance with the movement of the electronic apparatus 100 using the acceleration information. The correction information generating unit 1340 may calculate an azimuth of the AP 10 with respect to the direction which is changed by the movement of the electronic apparatus 1000 using the direction information. The correction information generating unit 1340 may transmit the generated correction information (that is, the calculated moving distance and the corrected azimuth) to the position information generating unit 1350.

The position information generating unit 1350 may generate the position information of the electronic apparatus 1000 using the distance from the AP 10 which is transmitted from the distance calculating unit 1310 and the azimuth for the position of the AP 10 which is transmitted from the azimuth calculating unit 1320, based on the position information of the AP 10 which is included in the AP signal.

The position information generating unit 1350 may correct the generated position information using the correction information which is transmitted from the correction information generating unit 1340. For example, when the distance between the electronic apparatus 1000 and the AP 10 is larger than a reference value, the position information generating unit 1350 may correct the position information using the correction information. This is because if the distance between the electronic apparatus 1000 and the AP 10 is large, the precision for generating the position information is lowered by the movement of the electronic apparatus 1000.

Referring to FIG. 2 again, the INS sensor 1400 may transmit the movement information in accordance with the change of the movement of the electronic apparatus 1000 to the correction information generating unit 1340 of the location estimating unit 1300.

The INS sensor 1400 may include, for example, an acceleration sensor (not illustrated) and a terrestrial magnetism sensor (not illustrated). The acceleration sensor measures acceleration in accordance with the movement of the electronic apparatus 1000 and the measured acceleration may be used to measure a speed and a movement distance of the electronic apparatus 1000. As for the acceleration sensor, for example, a piezoelectric accelerometer which uses an effect of converting a mechanical property of piezoelectric materials into an electric property may be used. When shear force is applied in addition to compressive force, an accelerometer which converts the mechanical property into the electric property may be used. Various types of acceleration sensors such as vibration type, strain gauge type, electrodynamic, and servo-type acceleration sensors may be used. The terrestrial magnetism sensor is a sensor which evaluates a flow of a magnetic field which is generated in the earth to detect a point of the compass and may be used to estimate a movement direction of the electronic apparatus 1000.

The transmitting unit 1500 may transmit the position information which is generated by the location estimating unit 1300 to another electronic apparatus, terminal, or server. Even though the transmitting unit 1500 is illustrated as a separate component from the receiving unit 1200 in FIG. 2, the transmitting unit 1500 may be configured to be integrated with the receiving unit 1200.

The display unit 1600 may output the position information which is generated by the location estimating unit 1300. For example, the electronic apparatus 1000 may execute various applications (for example, an application which provides a position based service) and the position information of the electronic apparatus 1000 may be displayed on a screen which is output to the display unit 1600 as the application is executed.

In the meantime, the display unit 1600 may include at least one of a liquid crystal display (LCD), a thin film transistor (TFT) LCD, a light emitting diode (LED), an organic LED (OLED), an active matrix OLED (AMOLED), a flexible display, a bended display, and a three-dimensional display. Some of the above displays may be implemented by a transparent display which is configured to be a transparent type or an optically transparent type so as to see the outside. The display unit 1600 may be implemented as a touch screen which includes a touch panel.

As described above, the location estimating unit 1300 according to an exemplary embodiment of the present invention calculates the azimuth with respect to the position of the AP 10 and the distance from the AP 10 using the AP signal which is received from one AP 10 and generates the position information of the electronic apparatus 1000 using the azimuth and the distance which are calculated based on the position information of the AP 10 which is included in the AP signal. Therefore, it is possible to reduce cost for installing the AP 10. The location estimating unit 1300 corrects the position information using correction information which is generated using the detection information which is transmitted from the INS sensor 1400, which results in improving precision of the position information.

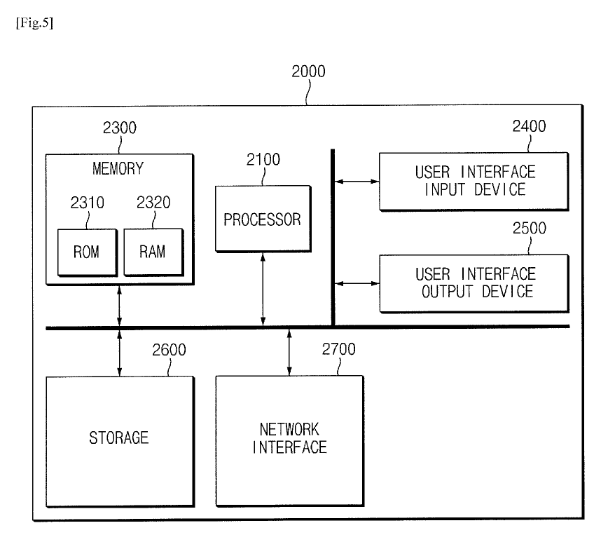

FIG. 4 is a flowchart illustrating a location estimating method according to an exemplary embodiment of the present invention.

Referring to FIG. 4, a location estimating method according to an exemplary embodiment of the present invention may include a step of calculating information on a distance from an AP in step S110, a step of calculating information on an azimuth of the AP in step S120, a step of acquiring position information of the AP from an AP signal in step S130, a step of estimating position information of the electronic apparatus using the distance information and the azimuth information based on the position information of the AP in step S140, and a step of correcting the position information which is estimated using the correction information in step S150.

Hereinafter, steps S110 to S150 will be described in more detail with reference to FIGS. 1 to 3.

In step S110, a receiving unit 1200 may receive an AP signal from an AP 10 (see FIG. 1) through an array antenna 1100. The AP signal may include an AP message including position information of the AP 10. For example, the position information of the AP 10 may be defined by a three-dimensional coordinate (x, y, z). The receiving unit 1200 may transmit the received AP signal to a location estimating unit 1300. A distance calculating unit 1310 of the location estimating unit 1300 may calculate the distance from the AP 10 using the strength RSSI of the AP signal. The distance from the AP 10 may indicate a distance between the electronic apparatus 1000 and the AP 10.

In step S120, an azimuth calculating unit 1320 of the location estimating unit 1300 may calculate an azimuth Φ (see FIG. 1) with respect to the position of the AP 10 using an entrance angle of the AP signal which is input to the array antenna 1100. For example, the azimuth may indicate a direction of the AP 10 with respect to the electronic apparatus 1000.

In step S130, a position information acquiring unit 1330 may acquire position information of the AP 10 from the received AP signal.

In step S140, a position information generating unit 1350 of the location estimating unit 1300 may generate the position information of the electronic apparatus 1000 using the distance from the AP 10 which is transmitted from the distance calculating unit 1310 and the azimuth for the position of the AP 10 which is transmitted from the azimuth calculating unit 1320, based on the position information of the AP 10.

In step S150, the position information generating unit 1350 of the location estimating unit 1300 may correct the generated position information using the correction information which is transmitted from the correction information generating unit 1340. For example, when the distance between the electronic apparatus 1000 and the AP 10 is larger than a reference value, the position information generating unit 1350 may correct the position information using the correction information.

In the meantime, a correction information generating unit 1340 of the location estimating unit 1300 may generate correction information based on detection information which is transmitted from the INS sensor 1400 (see FIG. 2). The detection information may include information on movement, acceleration, a direction, and a gradient of the electronic apparatus 1000 and for example, may include acceleration information and direction information. Specifically, the correction information generating unit 1340 may calculate a speed and a movement distance in accordance with the movement of the electronic apparatus 1000 using the acceleration information. The correction information generating unit 1340 may calculate an azimuth of the AP 10 with respect to the direction which is changed by the movement of the electronic apparatus 1000 using the direction information. The correction information generating unit 1340 may transmit the generated correction information (that is, the calculated moving distance and the corrected azimuth) to the position information generating unit 1350.

FIG. 5 is a block diagram illustrating a computing system which executes a location estimating method according to an exemplary embodiment of the present invention.

Referring to FIG. 5, a computing system 2000 may include at least one processor 2100, a memory 2300, a user interface input device 2400, a user interface output device 2500, a storage 2600, and a network interface 2700 which are connected to each other through a bus 2200.

The processor 2100 may be a semiconductor device which may perform processings on commands which are stored in a central processing unit (CPU), or the memory 2300 and/or the storage 2600. The memory 2300 and the storage 2600 may include various types of volatile or non-volatile storage media. For example, the memory 2300 may include a read only memory (ROM) and a random access memory (RAM).

A method or a step of algorithm which has been described regarding the exemplary embodiments disclosed in the specification may be directly implemented by hardware or a software module which is executed by the processor 2100 or a combination thereof. The software module may be stored in a storage medium (that is, the memory 2300 and/or the storage 2600) such as a RAM, a flash memory, a ROM, an EPROM, an EEPROM, a register, a hard disk, a detachable disk, or a CD-ROM. An exemplary storage medium is coupled to the processor 2100 and the processor 2100 may read information from the storage medium and write information in the storage medium. As another method, the storage medium may be integrated with the processor 2100. The processor and the storage medium may be stayed in an ASIC (application specific integrated circuit). The ASIC may be stayed in a user terminal. As another method, the processor and the storage medium may be stayed in a user terminal as individual components.

It will be appreciated that various exemplary embodiments of the present invention have been described herein for purposes of illustration, and that various modifications and changes may be made by those skilled in the art without departing from the scope and spirit of the present disclosure. Accordingly, the exemplary embodiments disclosed herein are not intended to limit but describe the technical spirit of the present invention and the scope of the technical spirit of the present invention is not restricted by the exemplary embodiments. The protection scope of the present invention should be interpreted based on the following appended claims and it should be appreciated that all technical spirits included within a range equivalent thereto are included in the protection scope of the present invention.

What is claimed is:

1. A location estimating apparatus which estimates a location of an electronic apparatus, the apparatus comprising:
a distance calculating unit which calculates a distance from an AP using a strength (RSSI) of an AP signal which is received from the AP;
an azimuth calculating unit which calculates an azimuth of the AP with respect to a reference direction using an entrance angle of the AP signal;
a position information acquiring unit which acquires position information of the AP from the AP signal;
a correction information generating unit which generates correction information based on detection information for movement of the electronic apparatus; and
a position information generating unit which generates position information of the electronic apparatus using the distance from the AP and the azimuth based on the position information of the AP and corrects the position information of the electronic apparatus using the correction information.

2. The location estimating apparatus of claim 1, wherein the location estimating apparatus is disposed in the electronic apparatus to receive the AP signal from the AP.

3. The location estimating apparatus of claim 1, wherein when the electronic apparatus is disposed inside, the reference direction is defined as a direction which is perpendicular to the ground.

4. The location estimating apparatus of claim 1, wherein the correction information includes acceleration information and direction information with respect to the movement of the electronic apparatus.

5. The location estimating apparatus of claim 1, wherein when the distance from the AP is larger than a reference value, the position information generating unit corrects the position information of the electronic apparatus using the correction information.

6. The location estimating apparatus of claim 1, wherein the AP signal includes a message which includes the position information of the AP.

7. The location estimating apparatus of claim 1, wherein when the electronic apparatus is disposed inside, the electronic apparatus receives the AP signal from the AP.

8. A location estimating method which estimates a location of an electronic apparatus, the method comprising:
calculating a distance from an AP using a strength (RSSI) of an AP signal which is received from the AP;
calculating an azimuth of the AP with respect to a reference direction using an entrance angle of the AP signal;
acquiring position information of the AP from the AP signal;
generating correction information based on detection information for movement of the electronic apparatus;
generating position information of the electronic apparatus using the distance from the AP and the azimuth based on the position information of the AP; and
correcting the position information of the electronic apparatus using the correction information.

9. An electronic apparatus, comprising:
a receiving unit which receives an AP signal from an AP;
an INS sensor which detects movement of the electronic apparatus to generate detection information; and
a location estimating unit which calculates a distance between the electronic apparatus and the AP using a strength (RSSI) of the AP signal, calculates an azimuth of the AP with respect to a reference direction using an entrance angle of the AP signal, generates the position information of the electronic apparatus using the distance and the azimuth based on the position information of the AP which is acquired from the AP signal, and corrects the estimated position information of the electronic apparatus using the correction information which is generated based on the detection information.

10. The electronic apparatus of claim 9, wherein the location estimating unit includes:
a distance calculating unit which calculates a distance from the AP;
an azimuth calculating unit which calculates an azimuth of the AP;
a position information acquiring unit which acquires position information of the AP from the AP signal;
a correction information generating unit which generates the correction information based on the detection information; and
a position information generating unit which generates position information of the electronic apparatus using the distance from the AP and the azimuth based on the position information of the AP and corrects the position information of the electronic apparatus using the correction information.

11. The electronic apparatus of claim 10, wherein when the distance from the AP is larger than a reference value, the position information generating unit corrects the position information of the electronic apparatus using the correction information.

12. The electronic apparatus of claim 10, wherein the correction information includes acceleration information and direction information with respect to the movement of the electronic apparatus.

13. The electronic apparatus of claim 10, wherein when the electronic apparatus is disposed inside, the reference direction is defined as a direction which is perpendicular to the ground.

14. A location estimating apparatus which estimates a location of an electronic apparatus, the apparatus comprising:
a distance calculating unit which calculates a distance from an AP using a strength (RSSI) of an AP signal which is received from the AP;
an azimuth calculating unit which calculates an azimuth of the AP with respect to a reference direction using an entrance angle of the AP signal;
a position information acquiring unit which acquires position information of the AP from the AP signal;
a position information generating unit which generates position information of the electronic apparatus using the distance from the AP and the azimuth based on the position information of the AP.
